(19) United States
(12) Patent Application Publication
(10) Pub. No.: US 2002/0198744 A1
(43) Pub. Date: Dec. 26, 2002

(54) Integrated suite of products/services for conducting business online

(76) Inventors: Ty Sagalow, Syosset, NY (US); Ray Berg, New York, NY (US)

Correspondence Address: PROSKAUER ROSE LLP, PATENT DEPARTMENT, 1585 BROADWAY, NEW YORK, NY, 10036, US

(21) Appl. No.: 10/045,658

(22) Filed: Oct. 26, 2001

Related U.S. Application Data
(60) Provisional application No. 60/243,601, filed on Oct. 26, 2000.
(60) Provisional application No. 60/243,547, filed on Oct. 26, 2000.
(60) Provisional application No. 60/244,157, filed on Oct. 27, 2000.
(60) Provisional application No. 60/243,567, filed on Oct. 26, 2000.

(51) Int. Cl. G06F 17/60

(52) U.S. Cl. 705/4

(57) ABSTRACT

An online suite of products and services to facilitate conducting business online includes web content insurance, network security insurance, goods inspection services, cargo insurance, trade credit insurance and services, identity assurance services, and an online process for the sale of such products. The inventive suite of products and services is not only applicable to the Internet, but also to other network environments, such as a LAN or a WAN.

### RELATED APPLICATIONS

The following Provisional Patent Applications, which are incorporated herein by reference, are related to the subject matter of the present invention, and are commonly assigned to the same assignee as is this application:

a) Patent Application No. 60/211,918, entitled “An On-Line Integrated Package for Trade Credit Insurance,” filed Jun. 16, 2000;

b) Patent Application No. 60/228,882, entitled “E-Cargo,” filed Aug. 29, 2000;

c) Patent Application No. 60/233,503, entitled “Internet Insurance Product,” filed Sep. 19, 2000;

d) Patent Application No. 60/243,601, entitled “Identity Insurance Transaction Method,” filed Oct. 26, 2000; and

e) Patent Application No. 60/243,547, entitled “Process for Online Sale of an Internet Insurance Product,” filed substantially concurrently herewith.

### BACKGROUND OF THE INVENTION

The present invention relates to Business-to-Business (B2B) eCommerce transactions. More specifically, the present invention relates to a suite of products and services that facilitates conducting business online.

Due to the real-time, and often anonymous nature of B2B eCommerce transactions, participants face unique risks that require completely new solutions. Buyers and Sellers on the Internet need to better understand with whom they are doing business, and they need purchase protection before closing a deal. By mitigating B2B transaction risks, such as counterparty selection, goods specification, transit, payment, site failure, etc., trading partners will gain confidence that their transactions are safe, and will be motivated to transact more of their business online.

A website offering a suite of insurance products, risk management services and information resources would enable a user to pick and choose among the various products and services offered. With the appropriate protections in place, the risks and potential frictions between B2B trading partners would be significantly reduced, thus enhancing trust and liquidity in the eCommerce marketplace.

The types of products and services that can provide security and risk management for Internet transactions include credit analysis, content liability, network security, identity authentication, shipping insurance, goods inspection and certification, among others.

For example, B2B exchanges offer Sellers the opportunity to access new Buyers located worldwide, but this brings uncertainties and risks for the Seller in the management of new receivables. A Seller needs to know if the potential Buyer is real, and if he is creditworthy. A Seller might also want to monitor a Buyer's financial stability over a period of time, to be forewarned of any significant change in a Buyer's creditworthiness.

Another area of concern to a Seller is content liability and security on the Seller's website. Errors and omissions, loss of information assets, eBusiness interruption and network security failures are some of the Internet-related risks that a Seller must contend with, and should be protected against.

Moreover, the shipment of goods to and from worldwide locations involves many kinds of transit risks, such as bad weather, theft, and damage or destruction. Since carriers typically have limited liability, additional insurance is required for complete shipping protection.

Finally, it is often desirable to verify the quality of goods being supplied, especially when trading with an unknown partner. Inspection and testing services can be made available to provide the confidence that the physical goods will meet precise specifications and quality standards.

Accordingly, it is an object of the present invention to define an integrated suite of products and services that incorporates all of the features described above, to enhance the transaction of online business.

It is a further object of the present invention to serve as an evolving platform for offering additional value-added transactional services.

### SUMMARY OF THE INVENTION

In accordance with an illustrative embodiment of the present invention, a suite of products and services for facilitating an online business transaction comprises:

a. an Internet insurance product,

b. an online sale process for the Internet insurance product,

c. a goods inspection service,

d. a cargo insurance product,

e. a trade credit insurance product, and

f. an identity assurance product,

where the entire suite of products and services is accessible online.

The Internet insurance product includes many types of online coverages, including web content liability, professional errors and omissions, network security liability, and cyber extortion, among others.

The goods inspection service includes third-party inspection, testing, certification and quality assurance services.

The cargo insurance product provides shipping protection, and can be purchased online for a single shipment. Also, the cargo insurance product covers air, sea, road, rail and barge shipments.

The trade credit insurance product comprises a number of services, including credit analysis, risk management, portfolio monitoring, billing and recovery services.

The identity assurance product provides authenticated identification of the participants in online business transactions.

The inventive suite of products and services is provided in digital media form, and can be used in any network environment, such as a LAN or a WAN, as well as on the Internet.

### BRIEF DESCRIPTION OF THE DRAWING

The invention is described in greater detail below through the example of embodiments shown in the drawing, wherein:

FIGS. 1A and 1B depict a site map for a website, in accordance with the invention.

### DETAILED DESCRIPTION OF PREFERRED EMBODIMENTS OF THE INVENTION

In accordance with an embodiment of the present invention, on online suite of insurance products and services is offered on an Internet website. This inventive suite is designated herein as “Avantrust”, and includes, illustratively, the types of products and services described below, as well as the process flows for implementing these products and services.

“AIGnetAdvantagesm^{SM} Suite”

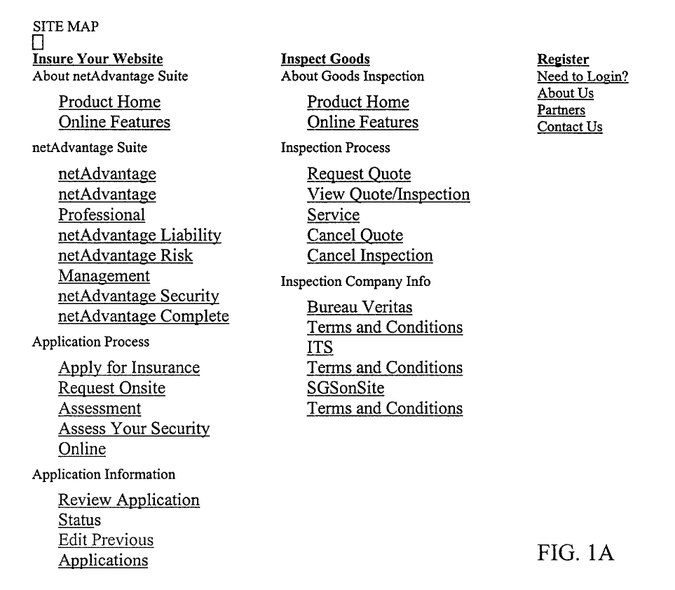

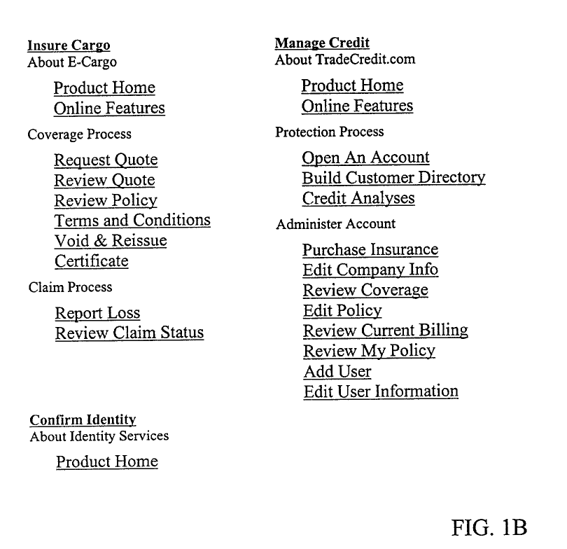

“AIGnetAdvantage^{SM} Suite” is a suite of Internet insurance products, which is more fully described in Patent Application No. 60/233,503, entitled “Internet Insurance Product.” As indicated in FIG. 1A, AIGnetAdvantage^{SM} Suite includes coverages for web content liability, intellectual property infringement, professional liability and losses arising out of a failure of network security. AIGnetAdvantage^{SM} Suite also includes the online resources for the user's selection of insurance coverages, and for the insurance underwriter's assessment and quotation process. AIGnetAdvantage^{SM} Suite is organized into five major policies, each of which is designed for a particular type of E-business protection. The five policies and their primary coverages are:

AIGnetAdvantage^{SM}—for companies that use the Internet for advertising and marketing activities;

AIGnetAdvantage Professional^{SM}—for companies rendering professional services via the web, or serving e-clients;

AIGnetAdvantage Liabilitys^{SM}—an extensive third-party Internet liability coverage for any company using the Internet;

AIGnetAdvantage Security^{SM}—robust protection for web content and network security risks for any company using the Internet;

AIGnetAdvantage Complete^{SM}—total protection for web content, professional services and network security for any company using the Internet.

An eMarketplace can buy the AIGnetAdvantage^{SM} Suite products for itself, or can offer them to its participants, gaining an increased level of trust for the exchange in either case. The AIGnetAdvantage^{SM} Suite includes the availability of product marketing materials, online quote applications, online security audit request forms, online network security assessments and online screens for status information.

Application Process

An online process for the sale of insurance products, such as AIGnetAdvantage^{SM} Suite, is outlined in FIG. 1A under the heading “Application Process.” This process is more fully described in Patent Application No. 60/243,547, entitled “Process for Online Sale of an Internet Insurance Product.” The online sale process includes an online application form with a menu of available insurance coverages. A user selects the coverages he wants, and completes the online application. The insurance underwriter performs a risk analysis, based on the user's online self-assessment, or on the underwriter's own security assessment. If the user is approved, an online quote is generated, and offered to the user. The user can then either accept or reject the quote online.

Goods Inspection, Testing and Certification

FIG. 1A also shows a website layout for an optional inspection process, for the verification of goods quality. This process would typically involve the partnership services of an independent inspection and testing firm, such as Bureau Veritas, Intertek Testing Services (ITS), or SGS onSite, to ensure that purchased goods are received as expected. A user can request quotes, and review the terms and status conveniently online.

The partnership between the Avantrust suite and outside inspection services enables a user to conveniently select an inspection service company that will accommodate the user's particular requirements. These third-party companies can provide worldwide inspection, certification, performance and safety testing, and quality assurance programs, among other services. And, no matter which service a user chooses, the user can conduct all his business online, including quotes, terms of the contract, status reports, and billing.

E-Cargo

Cargo insurance is also available, as indicated under “E-Cargo” in FIG. 1B, in order to protect against shipping risks. This type of coverage is more fully described in Patent Application No. 60/228,882, entitled “E-Cargo.” Whereas cargo insurance has traditionally been purchased as an “open” policy, covering all declared shipments during the term of the policy, the inventive E-Cargo coverage can be purchased for a single shipment. Moreover, E-Cargo single shipment insurance can be procured by a customer directly, online in real time at an eMarketplace site, and at a competitive price. All types of shipments can be covered, including air, sea, road, rail and barge.

The E-Cargo insurance certificate and quote will be customized to the customer, and will be based on the risk of the individual shipment (type of goods being shipped, origin and destination, mode of transportation, size of shipment). Additional features of E-Cargo include online insurance purchase and confirmation, online rating and risk evaluation, online certificate issuance, online claims notification, and online request to void a certificate. With the protections offered by E-Cargo, an eMarketplace customer will have the confidence to complete a transaction, and feel comfortable knowing that if there is a loss due to physical damage of the goods shipped, the E-Cargo insurance will cover the loss.

Identity Services

As indicated under “Confirm Identity” in FIG. 1B, Avantrust Identity Services provides confidence that the trading environment is secure, with the knowledge that a company and its online trading partners have been authenticated. This process is more fully described in Patent Application No. 60/243,601, entitled “Identity Insurance Transaction Method.” Through its partnership with an information services company, such as Dun & Bradstreet, Avantrust Identity Services can authenticate companies and individuals, using Dun & Bradstreet's database of corporate records and call-center capabilities. As a result, exchanges can attract more liquidity by providing a heightened trust environment, and participants can transact business with peace of mind.

Features of Avantrust Identity Services include pre-identification of participants, assurance for Sellers that Buyers are who they say they are, worldwide availability, and Best Practices on how eMarketplaces and Member Organizations can perform specific activities to protect themselves and their online businesses.

TradeCredit.com

Credit risk is managed within the Avantrust suite through TradeCredit.com, as indicated under “Manage Credit” in FIG. 1B. This feature is more fully described in Patent Application No. 60/211,918, entitled “An On-Line Integrated Package for Trade Credit Insurance.” Sellers can feel more confident when doing business online with TradeCredit.com, and can access this online “Credit Department” at a fraction of the cost of building a department internally. TradeCredit.com provides a total credit management solution, from credit analysis and insurance through to payment. Further, it can be used to manage a portfolio of Buyers, or on a transaction-by transaction basis, no matter what the needs of the participants.

Features of TradeCredit.com include a virtual “Credit Analyst”, for evaluating Buyers and setting credit limits, a virtual “Risk Manager” to provide online credit insurance to protect the Seller, a virtual “Portfolio Monitor” to track the Buyer's financial stability and creditworthiness, and a virtual “Collections Specialist” to provide professional recovery services at a fraction of market costs.

With TradeCredit.com, Sellers can have an online Credit Department offering the following benefits:

a. Credit analysis and credit limits for Buyers, using proprietary algorithms;

b. Online identification, matching and investigation of companies;

c. Insurance against the risk of non-payment;

d. Online underwriting quotes and generation of policy documentation;

e. Online submission of overdue receivables for collection;

f. Online billing of premium and fees;

g. Online monitoring and notification on companies with deteriorating financial condition;

h. Tracking of premium and claims payments; and

i. Real-time credit assessments of Buyers.

TradeCredit.com is readily accessible, easy to use, and information is secured through sophisticated encryption technology.

In short, an online suite of products and services (Avantrust Suite) is disclosed, which enables Sellers and Buyers to conduct business on the eMarketplace with full confidence that their transactions will be legitimate and secure.

Moreover, the disclosed suite of products and services can also be used in other types of network environments; e.g., a LAN or a WAN, etc.

While the invention has been described by reference to specific embodiments, this was for purposes of illustration only and should not be construed to limit the scope of the invention. Numerous alternative embodiments will be apparent to those skilled in the art.

1. A suite of products and services for facilitating an online business transaction, said suite comprising:
a. an Internet insurance product for said online business transaction,
a. an online sale process for said Internet insurance product,
b. a goods inspection service for said online business transaction,
c. a cargo insurance product for said online business transaction,
d. a trade credit insurance product for said online business transaction, and
e. an identity assurance product for said online business transaction,
wherein said suite of products and services are accessible online.

2. The suite of products and services of claim 1 wherein said Internet insurance product covers web content liability.

3. The suite of products and services of claim 1 wherein said Internet insurance product covers professional errors and omissions.

4. The suite of products and services of claim 1 wherein said Internet insurance product covers network security liability.

5. The suite of products and services of claim 1 wherein said Internet insurance product covers cyber extortion.

6. The suite of products and services of claim 1 wherein said goods inspection service comprises inspection, testing, certification and quality assurance.

7. The suite of products and services of claim 1 wherein said cargo insurance product is purchased online for a single shipment.

8. The suite of products and services of claim 7 wherein said cargo insurance product covers air, sea, road, rail and barge shipments.

9. The suite of products and services of claim 1 wherein said trade credit insurance product comprises online services, including credit analysis, risk management, portfolio monitoring, billing and recovery services.

10. The suite of products and services of claim 1 wherein said identity assurance product comprises authenticated identification of participants in said online business transaction.

11. The suite of products and services of claim 1 wherein said suite is accessible in a network environment, such as a LAN or a WAN.

12. The suite of products and services of claim 1 wherein said suite is in digital media form.
